(19) United States
(12) Patent Application Publication
(10) Pub. No.: US 2007/0131146 A1
(43) Pub. Date: Jun. 14, 2007

(54) Environmental protection material and brick made of the material

(76) Inventor: Kwok Lung Wong, Hong Kong (HK)

Correspondence Address: J.C. Patents, Suite 250, 4 Venture, Irvine, CA, 92618, US

(21) Appl. No.: 11/370,484

(22) Filed: Mar. 7, 2006

(30) Foreign Application Priority Data
Dec. 9, 2005 (HK) 05111307.0

(51) Int. Cl. C04B 18/18

(52) U.S. Cl. 106/697

(57) ABSTRACT

The present invention relates to an environmental protection material comprising 50-70% wood fiber, 45-25% curing agent and 3-10% waterproof additive. The present invention effectively reuses the wood wastes to protect the environment. A brick made of the present material is also disclosed.

### TECHNICAL FIELD

The present invention relates to an environmental protection material, and in particular to an environmental protection material made of wood wastes and a brick made of the material.

### BACKGROUND OF THE INVENTION

In our daily life, a large amount of construction wastes are created, including wood, concrete, plastics and cement. It becomes a serious problem to the society to deal with such wastes. These wastes are usually dumped. As more and more people realize the importance of the environmental protection, technologies for reusing such wastes are developed. See for example Hong Kong short-term patent No. 1043490 and 1043907.

However, there is no simple and effective method to reuse various wood wastes in the prior art.

### BRIEF DESCRIPTION OF THE DRAWINGS

The present invention is described with reference to the following drawing:

FIG. 1 shows a brick made of the environmental protection material of the present invention.

### SUMMARY OF THE INVENTION

In view of the problems existing in the prior art, the object of the present invention is to provide an environmental protection material made of waste wood with a low cost.

In order to achieve the above said object, the present invention provides an environmental material comprising 50-70% wood fiber, 25-45% curing agent and 3-10% waterproof additive by volume.

The curing agent may be two-component polymer modified cementitious screed mortar, or any commercial cement, and the waterproof additive may be any kind of waterproof additives, such as styrene butadiene copolymer or any glue.

The wood fiber used in the material may be in form of scraps or any suitable form.

The present invention also provides a brick made of the material for construction and decoration engineering.

The present invention effectively reuses the wood wastes to protect the environment.

### DETAILED DESCRIPTION OF THE PREFERRED EMBODIMENTS

In order to make the material of the present invention, the first step is to crush the wood into fine scraps or powder. Then, a curing agent is added to set the scraps into a certain shape.

In order to avoid deformation caused due to a humid environment, a waterproof additive may be incorporated into the mixture of the wood fiber and the curing agent, such as styrene butadiene liquid.

The final composite material may comprise 50-70% wt of wood fiber, 25-45% curing agent and 3-10% waterproof additive.

In one preferred embodiment, the curing agent is two-component polymer modified cementitious screed mortar.

The material of the present invention has a wood-like appearance. It can be moulded to form bricks or other construction elements for construction and decoration engineering.

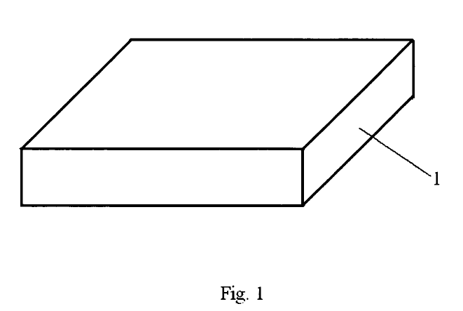

FIG. 1 shows a brick made of the material of the present invention. Such brick 1 may be used to build partition walls. As compared with the conventional brick, the present brick is lightweight and the partition wall built by the brick is hard enough and imposes less pressure to the foundation of the building than those convention cement or concrete walls. In addition, the surface of such wall is easier to be treated. Since its surface is smoother than the convention wall, the wall can be grouted directly without patching. The further advantage is that the wall can tightly hold the fastening elements, e.g. screws.

All kinds of wood wastes can be used to form the material of the present invention. After used, the articles or construction elements made of the material can be collected and recycled. Thus, the problems raised by the waste wood may be resolved in an effective and simple way.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An environmental protection material, characterized in that it comprises 50-70% wood fiber, 25-45% curing agent and 3-10% waterproof additive.

2. The environmental material as claimed in claim 1, the curing agent comprises two-component polymer modified cementitious screed mortar.

3. The environmental material as claimed in claim 1, the waterproof additive comprises styrene butadine liquid.

4. The environmental material as claimed in claim 1, characterized in that the wood fiber is in form of scraps.

5. A brick made of the environmental protection material as claimed claim 1, for construction and decoration engineering.

6. A brick made of the environmental protection material as claimed claim 2, for construction and decoration engineering.

7. A brick made of the environmental protection material as claimed claim 3, for construction and decoration engineering.
